(19) United States
(12) Patent Application Publication
(10) Pub. No.: US 2016/0299166 A1
(43) Pub. Date: Oct. 13, 2016

(54) FULLY AUTOMATIC TEST CARD CONVEYING APPARATUS FOR INSTANT TESTING INSTRUMENT

(71) Applicant: HANGZHOU JOINSTAR BIOMEDICAL TECHNOLOGY CO., LTD., Hangzhou, Zhejiang (CN)

(72) Inventors: Xuyi ZHOU, Hangzhou, Zhejiang Province (CN); Longbin HONG, Hangzhou, Zhejiang Province (CN); Wenjie XU, Hangzhou, Zhejiang Province (CN); Xiaodong CHEN, Hangzhou, Zhejiang Province (CN); Songbing ZHOU, Hangzhou, Zhejiang Province (CN); Guojin SHEN, Hangzhou, Zhejiang Province (CN); Rui HU, Hangzhou, Zhejiang Province (CN)

(21) Appl. No.: 15/101,161

(22) PCT Filed: Dec. 25, 2014
(86) PCT No.: PCT/CN2014/094936

§ 371 Date: Jun. 2, 2016

(30) Foreign Application Priority Data
Dec. 26, 2013 (CN) 201320866370.4

(51) Int. Cl. G01N 35/02; G01N 35/00; G01N 35/04

(52) U.S. Cl. CPC G01N 35/021; G01N 35/04; G01N 35/00029; G01N 2035/0465; G01N 2035/00148

(57) ABSTRACT

Disclosed is a fully automatic test card conveying apparatus for an instant testing instrument. The fully automatic test card conveying apparatus for an instant testing instrument is used for conveying a test card, and comprises a test card conveying arm, a frame, a push rod, a buffer support, a buffer cartridge and a card extraction mechanism. A first electric motor, a second electric motor, a first sliding rail and a second sliding rail are provided on the test card conveying arm. The frame is connected in a sliding manner to the first sliding rail via a sliding block, and is connected to the first electric motor via a first synchronization belt. A stepping motor is provided on the sliding block, and an output end of the stepping motor is connected to the frame. The push rod is connected in a sliding manner with the second sliding rail, and is connected to the second electric motor via a second synchronization belt. The fully automatic test card conveying apparatus for an instant testing instrument has a simple structure and is convenient for conveying.

### FIELD OF THE INVENTION

The utility model relates to the technical field of medical testing apparatus, in particular, to a fully automatic test card conveying apparatus for an instant testing instrument.

### BACKGROUND OF THE INVENTION

Currently there are many medical testing apparatuses available on the markets, with high degree of automation and high detection capacity; but they require complicated sample pre-treatment processes and a long time of detection cycle, especially the test card conveying mechanism is complicated, with less stability. The existing POCT products can achieve a miniature, immediate and simple bedside testing, but POCT has a common feature—single detection; if there are many clinical samples of specimens in batches or the number of specimens for the same test item in the emergency testing is large, the single, small POCT testing instruments can not meet their requirements; moreover, their degree of automation is not high, requiring manual operation.

### SUMMARY OF THE INVENTION

The utility model provides a fully automatic test card conveying apparatus for an instant testing instrument. It has a simple structure and is convenient for conveying.

The utility model is achieved through the following technical solutions:

A fully automatic test card conveying apparatus for an instant testing instrument is used for conveying a test card, comprising a test card conveying arm, a frame, a push rod, a buffer support, a buffer cartridge and a card extraction mechanism, wherein a first electric motor, a second electric motor, a first sliding rail and a second sliding rail are provided on the test card conveying arm, the frame is connected in a sliding manner to the first sliding rail via a sliding block, and is connected to the first electric motor via a first synchronization belt. A stepping motor is provided on the sliding block, and an output end of the stepping motor is connected to the frame. The push rod is connected in a sliding manner with the second sliding rail, and is connected to the second electric motor via a second synchronization belt. The buffer support is arranged on one side of the test card conveying arm, provided with a third motor and a third sliding rail, the buffer cartridge is connected with the third sliding rail in a sliding manner and connected to the third electric motor via a third synchronization belt. The card extraction mechanism is arranged on the frame.

The card extraction mechanism comprises a first DC electric motor, a screw rod, a test card bracket, a fourth sliding rail and a hook bar. The test card bracket and the fourth sliding rail are fixed on the frame. The hook bar is connected with the fourth sliding rail in a sliding manner; the output end of the first DC electric motor is provided with a driving wheel; one end of the screw rod is provided with a driven wheel, and the other end is connected with the hook bar. The driving wheel is meshed with the driven wheel.

The buffer cartridge comprises a plurality of longitudinally arranged buffer brackets.

A holder block is arranged on the test card conveying arm, and the holder block is provided with a photoelectric sensor.

The utility model can achieve the following beneficial effects:

The fully automatic test card conveying apparatus for an instant testing instrument in the utility model is used for preparation for the subsequent testing by taking out the test card from the stack and putting into the buffer cartridge. The card extraction mechanism can rotate corresponding angle driven by the first DC electric motor to convey the detection card to the buffer cartridge. The hook bar can stretch into the stack to take the detection card driven by a stepping motor, and hook the detection card into the test card bracket. The frame rotates 90° driven by the stepping motor. The buffer cartridge can move up and down driven by the third motor, to convey the detection card into any one buffer bracket in the buffer cartridge for temporary storage. The push rod can push the detection card into the buffer bracket driven by the second electric motor when the frame is butted against the buffer cartridge. The photoelectric sensor is used for induction of the detection card passing from below and counting. The holder block is provided with a photoelectric sensor to monitor whether the detection card is available, and monitor whether the detection card is successfully conveyed to the buffer cartridge, to identify the barcodes of the detection card, so as to ensure the stable conveying.

### BRIEF DESCRIPTION OF THE DRAWINGS

The utility model is further described in combination with the drawings.

FIG. 1 is a schematic diagram of a fully automatic test card conveying apparatus for an instant testing instrument under the first state.

FIG. 2 is a schematic diagram of a fully automatic test card conveying apparatus for an instant testing instrument under the second state.

FIG. 3 is a schematic diagram a fully automatic test card conveying apparatus for an instant testing instrument under the third state.

The names of parts in the figures are as follows:

1, test card; 2, test card conveying arm; 3, frame; 4, push rod; 5, buffer support; 6, buffer cartridge; 7, first electric motor; 8, second electric motor; 9, first sliding rail; 10, second sliding rail; 11, sliding block; 12, first synchronization belt; 13, stepping motor; 14, second synchronization belt; 15, third motor; 16, third sliding rail; 17, third synchronization belt; 18, first DC electric motor; 19, screw rod; 20, test card bracket; 21, fourth sliding rail; 22, hook bar; 23, driving wheel; 24, driven wheel; 25, buffer bracket; 26, holder block; 27, photoelectric sensor.

### DETAILED DESCRIPTION OF THE EMBODIMENTS

The utility model is further described in details in combination with drawings and embodiments.

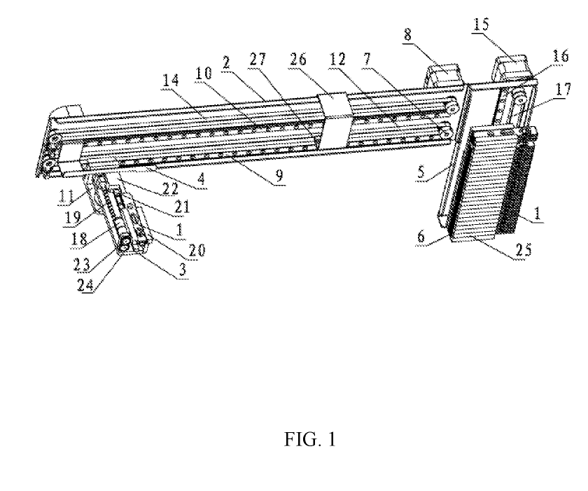

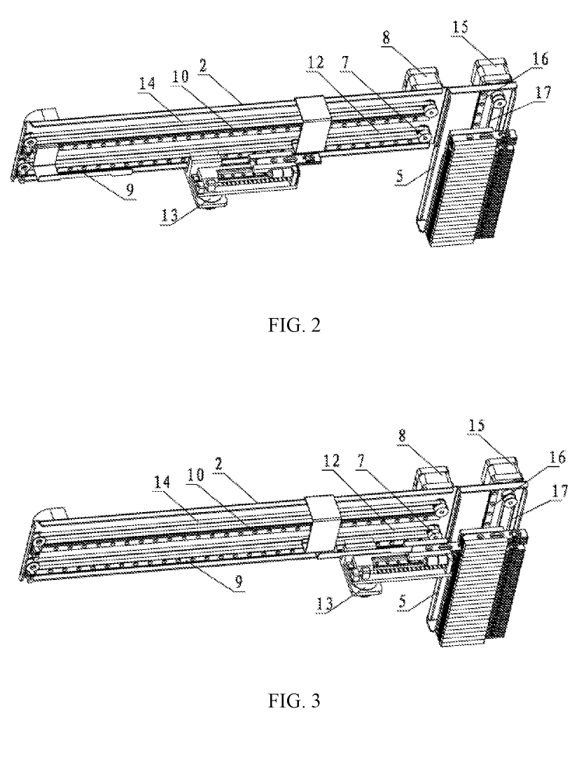

By referring to FIG. 1, FIG. 2 and FIG. 3, a fully automatic test card conveying apparatus for an instant testing instrument is used for conveying a test card 1, comprising a test card conveying arm 2, a frame 3, a push rod 4, a buffer support 5, a buffer cartridge 6 and a card extraction mechanism, wherein a first electric motor 7, a second electric motor 8, a first sliding rail 9 and a second sliding rail 10 are provided on the test card conveying arm 2, the frame 3 is connected in a sliding manner to the first sliding rail 9 via a sliding block 11, and is connected to the first electric motor 7 via a first synchronization belt 12. A stepping motor 13 is provided on the sliding block 11, and an output end of the stepping motor 13 is connected to the frame 3. The push rod 4 is connected in a sliding manner with the second sliding rail 10, and is connected to the second electric motor 8 via a second synchronization belt 14. The buffer support 5 is arranged on one side of the test card conveying arm 2, provided with a third motor 15 and a third sliding rail 16, the buffer cartridge 6 is connected with the third sliding rail 16 in a sliding manner and connected to the third electric motor 15 via a third synchronization belt 17. The card extraction mechanism is arranged on the frame 3. The buffer time of the detection card 1 in the buffer cartridge 6 is controllable, and different buffer time can be set depending on the specific test items.

In this embodiment, the card extraction mechanism comprises a first DC electric motor 18, a screw rod 19, a test card bracket 20, a fourth sliding rail 21 and a hook bar 22. The test card bracket 20 and the fourth sliding rail 21 are fixed on the frame 3. The hook bar 22 is connected with the fourth sliding rail 21 in a sliding manner; the output end of the first DC electric motor 18 is provided with a driving wheel 23; one end of the screw rod 19 is provided with a driven wheel 24, and the other end is connected with the hook bar 22. The driving wheel 23 is meshed with the driven wheel 24.

In this embodiment, the buffer cartridge 6 comprises twenty-five longitudinally arranged buffer brackets 25.

In this embodiment, a holder block 26 is arranged on the test card conveying arm 2, and the holder block 26 is provided with a photoelectric sensor 27.

1. A fully automatic test card conveying apparatus for an instant testing instrument is used for conveying a test card, comprising a test card conveying arm, a frame, a push rod, a buffer support, a buffer cartridge and a card extraction mechanism, wherein a first electric motor, a second electric motor, a first sliding rail and a second sliding rail are provided on the test card conveying arm, the frame is connected in a sliding manner to the first sliding rail via a sliding block, and is connected to the first electric motor via a first synchronization belt, a stepping motor is provided on the sliding block, and an output end of the stepping motor is connected to the frame, the push rod is connected in a sliding manner with the second sliding rail, and is connected to the second electric motor via a second synchronization belt; the buffer support is arranged on one side of the test card conveying arm, provided with a third motor and a third sliding rail, the buffer cartridge is connected with the third sliding rail in a sliding manner and connected to the third electric motor via a third synchronization belt, the card extraction mechanism is arranged on the frame.

2. The fully automatic test card conveying apparatus for an instant testing instrument according to claim 1, wherein the card extraction mechanism comprises a first DC electric motor, a screw rod, a test card bracket, a fourth sliding rail and a hook bar, the test card bracket and the fourth sliding rail are fixed on the frame, the hook bar is connected with the fourth sliding rail in a sliding manner, the output end of the first DC electric motor is provided with a driving wheel, one end of the screw rod is provided with a driven wheel, and the other end is connected with the hook bar, the driving wheel is meshed with the driven wheel.

3. The fully automatic test card conveying apparatus for an instant testing instrument according to claim 2, wherein the buffer cartridge comprises a plurality of longitudinally arranged buffer brackets.

4. The fully automatic test card conveying apparatus for an instant testing instrument according to claim 1, wherein a holder block is arranged on the test card conveying arm, and the holder block is provided with a photoelectric sensor.
